(19) United States
(12) Patent Application Publication
(10) Pub. No.: US 2018/0185807 A1
(43) Pub. Date: Jul. 5, 2018

(54) SPENT CATALYST STANDPIPES

(71) Applicant: SHELL OIL COMPANY, Houston, TX (US)

(72) Inventor: Cian Seamus CARROLL, Katy, TX (US)

(21) Appl. No.: 15/740,035

(22) PCT Filed: Jun. 28, 2016
(86) PCT No.: PCT/US2016/039727

§ 371 Date: Dec. 27, 2017

Related U.S. Application Data
(60) Provisional application No. 62/187,286, filed on Jul. 1, 2015.

(51) Int. Cl. B01J 8/18; B01J 38/30; C10G 11/18

(52) U.S. Cl. CPC B01J 8/1872; B01J 8/1818; B01J 2208/0084; C10G 11/182; B01J 2208/00752; B01J 38/30

(57) ABSTRACT

A catalyst standpipe comprising a horizontal section, a sloped section, and vertical section, wherein the vertical section comprises one or more ring portions and associated methods and systems.

### CROSS-REFERENCE TO RELATED APPLICATIONS

This application claims priority to U.S. Provisional Application Ser. No. 62/187,286 filed Jul. 1, 2015, the entire disclosure of which is hereby incorporated by reference.

### BACKGROUND

The present disclosure relates generally to catalyst standpipe flow distributors. More specifically, in certain embodiments, the present disclosure relates to spent catalyst standpipe flow distributors useful in fluid catalytic cracking operations and associated methods and systems.

In a typical Fluid Catalytic Cracking Unit (FCCU), finely divided regenerated catalyst is drawn from a regenerator through a regenerator standpipe and contacts with a hydrocarbon feedstock in a lower portion of a reactor riser. Hydrocarbon feedstock and steam enter the riser through feed nozzles. The mixture of feed, steam and regenerated catalyst, which has a temperature of from about 200° C. to about 700° C., passes up through the riser reactor, converting the feed into lighter products while a coke layer deposits on the surface of the catalyst, temporarily deactivating the catalyst.

The hydrocarbon vapors and catalyst from the top of the riser are then passed through cyclones to separate spent catalyst from the hydrocarbon vapor product stream. The spent catalyst enters a stripper where steam is introduced to remove hydrocarbon products from the catalyst. The spent catalyst then passes through a spent catalyst standpipe to enter the regenerator where, in the presence of gas and at a temperature of from about 620° C. to about 760° C., the coke layer on the spent catalyst is combusted to restore the catalyst activity. Regeneration is typically performed in a bubbling or fast fluidized bed. The regenerated catalyst may then be drawn from the regenerator fluidized bed through the regenerator standpipe and, in repetition of the previously mentioned cycle, contacts the feedstock in the reactor riser.

Catalyst regeneration is a critical step in FCCU operations. The success of the step depends on the contacting efficiency between the spent catalyst and oxygen-containing gas in the regenerator. Catalyst may be injected into the regenerator in a number of different ways. One conventional way of introducing catalyst into a regenerator is injecting the catalyst into a regenerator through a spent catalyst riser. Examples of such spent catalyst distributors and related systems, methods, and apparatus are described in U.S. Pat. No. 6,797,239, the entirety of which is hereby incorporated by reference.

While such existing systems may be effective, their use may not always ensure uniform catalyst distribution within the regenerator. When a spent catalyst riser is used to deliver spent catalyst using a conveying gas to the regenerator spent catalyst distributor in a regenerator, the spent catalyst and gas may not move uniformly through the pipe. Gas bubbles may tend to move along the one side of the spent catalyst riser while the catalyst particles tend to move along the other. In the case of a vertical spent catalyst riser, this may result in uneven distribution of spent catalyst and gas to the regenerator distributor. As a result of this non ideal distribution, the flow of spent catalyst and gas into the regenerator may be non-uniform reducing the effectiveness of the regenerator.

It is desirable to develop spent catalyst riser flow internals that promote more even distribution of spent catalyst and gas in the spent catalyst riser and subsequently delivered to the spent catalyst distributor within the regenerator.

### SUMMARY

The present disclosure relates generally to catalyst standpipe flow distributors. More specifically, in certain embodiments, the present disclosure relates to spent catalyst standpipe flow distributors useful in fluid catalytic cracking operations and associated methods and systems.

In one embodiment, the present disclosure provides a catalyst standpipe comprising a horizontal section, a sloped section, and vertical section, wherein the vertical section comprises one or more ring portions.

In another embodiment, the present disclosure provides a regenerator system comprising a catalyst distributor system comprising a catalyst standpipe comprising a horizontal section, a sloped section, and vertical section, wherein the vertical section comprises one or more ring portions, a gas line, a spent catalyst transfer line, and a distributor and a regenerator vessel.

In another embodiment, the present disclosure provides a method comprising: providing a regenerator system comprising a catalyst distributor system comprising a catalyst standpipe comprising a horizontal section, a sloped section, and vertical section, wherein the vertical section comprises one or more ring portions, a gas line, a spent catalyst transfer line, and a distributor and a regenerator vessel; introducing a flow of gas into the gas line; and introducing a flow of spent catalyst into the spent catalyst transfer line.

### BRIEF DESCRIPTION OF THE DRAWINGS

A more complete and thorough understanding of the present embodiments and advantages thereof may be acquired by referring to the following description taken in conjunction with the accompanying drawings.

FIG. 1 is an illustration of a catalyst standpipe insert in accordance with certain embodiments of the present disclosure.

FIG. 2 is an illustration of a catalyst standpipe in accordance with certain embodiments of the present disclosure.

FIG. 3 is an illustration of a catalyst standpipe system in accordance with certain embodiments of the present disclosure.

FIG. 4 is an illustration of a catalyst regenerator system in accordance with certain embodiments of the present disclosure.

FIG. 5 is an illustration of density profiles of various regenerator systems.

The features and advantages of the present disclosure will be readily apparent to those skilled in the art. While numerous changes may be made by those skilled in the art, such changes are within the spirit of the disclosure.

### DETAILED DESCRIPTION

The description that follows includes exemplary apparatuses, methods, techniques, and/or instruction sequences that embody techniques of the inventive subject matter. However, it is understood that the described embodiments may be practiced without these specific details.

The present disclosure relates generally to catalyst standpipe flow distributors. More specifically, in certain embodiments, the present disclosure relates to spent catalyst standpipe flow distributors useful in fluid catalytic cracking operations and associated methods and systems.

In certain embodiments, the present disclosure provides a new way to convey spent catalyst to a regenerator. In certain embodiments, the systems and methods discussed herein promote more even distribution of spent catalyst within both the catalyst standpipe riser and the regenerator than conventional systems. In certain embodiments, the systems and methods discussed herein allow for the reduction of the effects of back mixing in the spent catalyst riser system thus reducing pressure drop in the catalyst standpipe flow system.

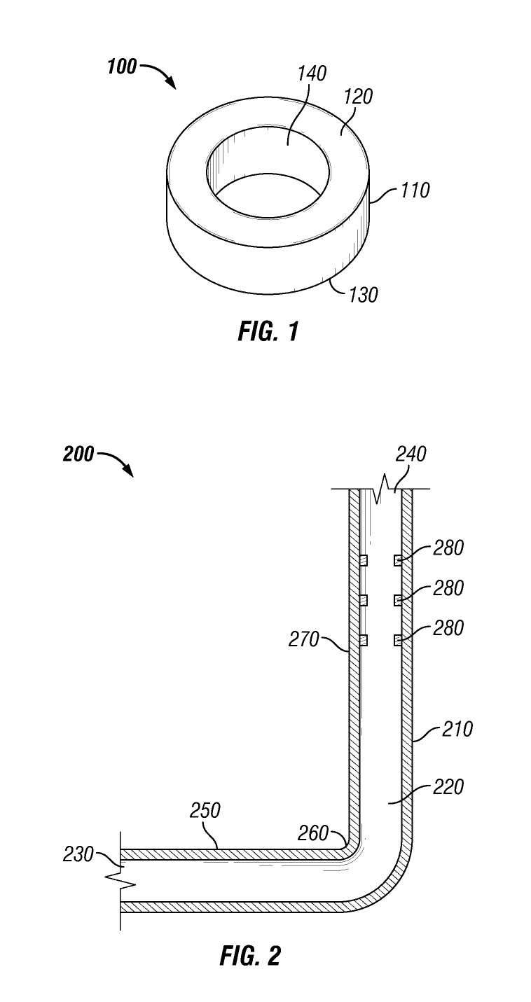

Referring now to FIG. 1, FIG. 1 illustrates a catalyst standpipe insert 100. In certain embodiments, catalyst standpipe insert 100 may comprise a solid annular structure defining a cavity. In certain embodiments, catalyst standpipe insert 100 may be constructed out of any of the following materials: metals, ceramics, and ceramets. In certain embodiments, catalyst standpipe insert 100 may be coated with refractory coatings and/or erosion resistant coatings. In certain embodiments, catalyst standpipe insert 100 may comprise a spent catalyst standpipe insert.

In certain embodiments, catalyst standpipe insert 100 may comprise outer surface 110, top surface 120, bottom surface 130, and inner surface 140.

In certain embodiments, catalyst standpipe insert 100 may of a height in the range of from 0.003 meters to 0.5 meters. In certain embodiments, catalyst standpipe insert 100 may have a height in the range of from 0.01 meters to 0.25 meters. In other embodiments, catalyst standpipe insert 100 may have a height in the range of from 0.05 meters to 0.1 meters.

In certain embodiments, catalyst standpipe insert 100 may have an outer diameter in the range of from 0.1 meters to 8 meters. In certain embodiments, catalyst standpipe insert 100 may have an outer diameter in the range of from 0.2 meters to 4 meters. In other embodiments, catalyst standpipe insert 100 may have an outer diameter in the range of from 0.5 meters to 1 meter.

In certain embodiments, catalyst standpipe insert 100 may have an inner diameter in the range of from 0.05 meters to 7 meters. In certain embodiments, catalyst standpipe insert 100 may have an inner diameter in the range of from 0.1 meters to 3.5 meters. In other embodiments, catalyst standpipe insert 100 may have an inner diameter in the range of from 0.25 meters to 0.5 meters.

In certain embodiments, catalyst standpipe may have a uniform cross-sectional profile. In certain embodiments, catalyst standpipe may have cross-sectional profile of a rectangle. In such embodiments, outer surface 110 and inner surface 140 may be parallel surface and bottom surface 130 and top surface 120 may be parallel surfaces.

In other embodiments, catalyst standpipe may have a non-rectangular cross-sectional profile. In such embodiments, bottom surface 130 and top surface 120 may be parallel surfaces and outer surface 110 and inner surface 140 may be non-parallel surface. In such embodiments, inner surface 140 may be a beveled surface and/or be a tapered surface and outer surface 110 may be a straight surface. In certain embodiments, inner surface 140 may be a straight, beveled, round, half bullnose, or full bullnose surface.

Referring now to FIG. 2, FIG. 2 illustrates catalyst standpipe 200. In certain embodiments, catalyst standpipe 200 may comprise a tubular wall 210 defining a hollow interior 220. In certain embodiments, tubular wall 210 may be constructed of metals, metal alloys, and/or ceramics and may be lined with erosion resistant coatings or ceramic lining. In certain embodiments, catalyst standpipe 200 may comprise a spent catalyst standpipe.

In certain embodiments, tubular wall 210 may comprise first end 230, second end 240, horizontal section 250, sloped section 260, and/or vertical section 270.

In certain embodiments, horizontal section 250 may have an inner diameter and an outer diameter. In certain embodiments, the outer diameter of horizontal section 250 may be in the range of from 0.3 meters to 3 meters. In certain embodiments, horizontal section 250 may have a uniform outer diameter. In other embodiments, horizontal section 250 may have a non-uniform outer diameter. In certain embodiments, the inner diameter of horizontal section 250 may be in the range of from 0.3 meters to 3 meters. In certain embodiments, horizontal section 250 may have a uniform inner diameter. In other embodiments, horizontal section 250 may have a non-uniform inner diameter. In certain embodiments, horizontal section 250 may have a wall thickness in the range of from 0.05 meters to 0.5 meters. In certain embodiments, horizontal section 250 may have a wall thickness in the range of from 0.1 meters to 0.5 meters.

In certain embodiments, sloped section 260 may have an inner diameter and an outer diameter. In certain embodiments, the outer diameter of sloped section 260 may be in the range of from 0.3 meters to 3 meters. In certain embodiments, sloped section 260 may have a uniform outer diameter. In other embodiments, sloped section 260 may have a non-uniform outer diameter. In certain embodiments, the inner diameter of sloped section 260 may be in the range of from 0.3 meters to 3 meters. In certain embodiments, sloped section 260 may have a uniform inner diameter. In other embodiments, sloped section 260 may have a non-uniform inner diameter. In certain embodiments, sloped section 260 may have a wall thickness in the range of from 0.05 meters to 0.5 meters. In certain embodiments, sloped section 260 may have a wall thickness in the range of from 0.1 meters to 0.5 meters.

In certain embodiments, vertical section 270 may have an inner diameter and an outer diameter. In certain embodiments, the outer diameter of vertical section 270 may be in the range of from 0.3 meters to 3 meters. In certain embodiments, the outer diameter of vertical section 270 may be the same as the outer diameter of horizontal section 250. In other embodiments, the outer diameter of vertical section 270 may be different than the outer diameter of horizontal section 250. In certain embodiments, horizontal section 270 may have a uniform outer diameter. In other embodiments, horizontal section 270 may have a non-uniform outer diameter.

In certain embodiments, the inner diameter of vertical section 270 may be in the range of from 0.3 meters to 3 meters. In certain embodiments, the inner diameter of vertical section 270 may be the same as the inner diameter of horizontal section 250. In other embodiments, the inner diameter of vertical section 270 may be different than the inner diameter of horizontal section 250. In certain embodiments, vertical section 270 may have a uniform inner diameter. In other embodiments, vertical section 270 may have a non-uniform inner diameter. In certain embodiments, vertical section 270 may have a wall thickness in the range of from 0.05 meters to 0.5 meters. In certain embodiments, vertical section 270 may have a wall thickness of from 0.1 meters to 0.3 meters.

In certain embodiments, vertical section 270 and/or horizontal section 250 may further comprise one or more ring portions 280. In certain embodiments, vertical section 270 and/or horizontal section 250 of catalyst standpipe 200 may comprise one, two, three, four, or five ring portions 280. In certain embodiments, each of the one or more ring portions 280 may be uniform. In other embodiments, one or more of the ring portions 280 may be non-uniform.

In certain embodiments, the one or more ring portions 280 may be protrusions of tubular wall 210 into hollow interior 220. In certain embodiments, the protrusions may extend up to 25% of the radius of hollow interior 220. In certain embodiments, the protrusions may extend in a range of from 0.1% to 25% of the radius of hollow interior 220. In certain embodiments, the protrusions may extend in a range of from 0.1% to 15% of the radius of hollow interior 220. In certain embodiments, the protrusions may extend in a range of from 0.2% to 10% of the radius of hollow interior 220.

In certain embodiments, the protrusion may each have a length in the range of from 0.01 meters to 0.3 meters. In certain embodiments, each protrusion may have a length in the range of from 0.01 meters to 0.5 meters. In certain embodiments, each protrusion may have a length in the range of from 0.1 meters to 0.15 meters.

In certain embodiments, the protrusions may cover an entire inner circumference of vertical section 270 and/or horizontal section 250. In certain embodiments, the protrusions may cover only a portion of an inner circumference of vertical section 270 and/or horizontal section 250.

In other embodiments, the one or more ring portions 280 may comprise inserts. In certain embodiments, the one or more ring portions 280 may comprise any combination of features discussed above with respect to catalyst standpipe inserts 100. In certain embodiments, the inserts may be constructed out of any of the following materials: metals, ceramics, and ceramets. In certain embodiments, the inserts may be coated with refractory coatings and/or erosion resistant coatings. In certain embodiments, the inserts may be attached to an inner surface of tubular wall by anchoring them to the riser wall using metal anchors. In certain embodiments, the inserts may be ring shaped with an outer diameter equal to the inner diameter of vertical section 270 and an inner diameter of 50% to 99% of the outer diameter.

In certain embodiments, the ring portions 280 may be placed at any location within catalyst standpipe 200. In certain embodiments, a first ring portion 280 may be placed a distance in the range of from 1 to 5 riser diameters from a pipe turn or a tee. In certain embodiments, a first ring portion 280 may be placed a distance in the range of from 5 to 10 riser diameters from a pipe turn or a tee. In other embodiments, a first ring portion 280 may be placed a distance of more than 10 riser diameters from a pipe turn or a tee. In certain embodiments, one or more ring portions 280 may be spaced at least 0.2 riser diameters apart from each other. In certain embodiments, one or more ring portions 280 may be spaced at most 10 riser diameters away from each other.

In certain embodiments, the one or more rings portions 280 may be capable creating a reduced effective inner diameter of vertical section 270 and/or horizontal section 250 at each of the one or more ring portions 280. While not wishing to be limited to theory, it is believed that by creating a reduced effective inner diameter, the mixing between solids and gas phases can be improved, forcing the contacting of the gas phase into the denser solids phase. The improved contacting is believed to improve the homogeneity of the density and velocity profile for improved system performance. It is also believed that the use of the ring portions 280 mitigate riser backflow along the wall, reducing associated pressure drop.

In certain embodiments, catalyst standpipe 200 may be sized to permit the flow of gas and solids through catalyst standpipe 200. In certain embodiments, catalyst standpipe 200 may be sized to permit the flow of gas and solids through catalyst standpipe at flow rates in the range of from 10 Mlb/h to 5000 Mlb/h. In certain embodiments, catalyst standpipe 200 may be sized to allow the flow of solids through catalyst standpipe 200 at flow rates in the range of from 5 tons/min to 500 tons/min.

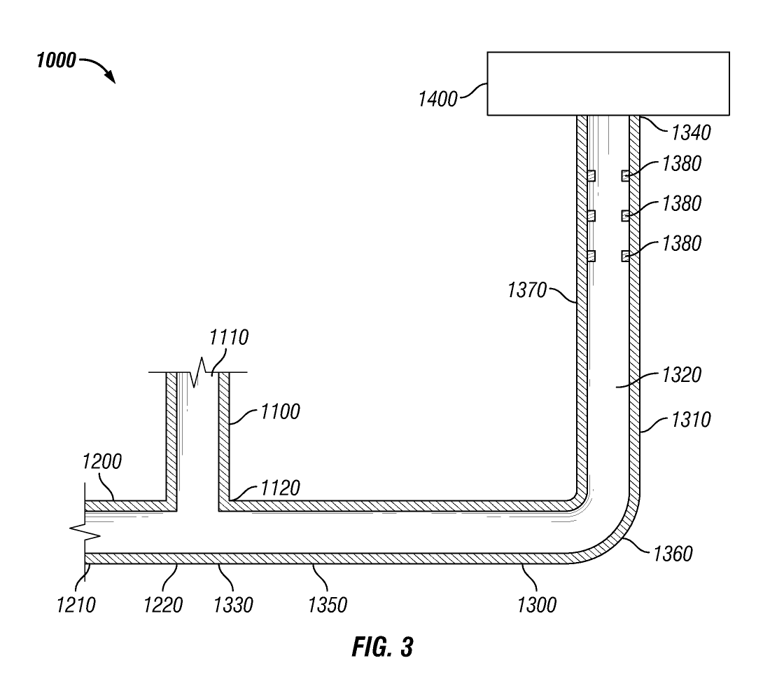

Referring now to FIG. 3, FIG. 3 illustrates catalyst distributor 1000 in accordance with certain embodiments of the present disclosure. In certain embodiments, catalyst distributor 1000 may comprise a spent catalyst distributor. As can be seen in FIG. 3, in certain embodiments, spent catalyst distributer 1000 may comprise spent catalyst line 1100, gas line 1200, catalyst standpipe 1300, and distributor 1400. In certain embodiments, spent catalyst line 1100, gas line 1200, catalyst standpipe 1300, and distributor 1400 may be in fluid communication with each other.

In certain embodiments, catalyst standpipe 1300 may comprise any combination of features discussed above with respect to catalyst standpipe 200. In certain embodiments, catalyst standpipe 1300 may comprise tubular wall 1310, a hollow interior 1320, first end 1330, second end 1340, horizontal section 1350, sloped section 1360, vertical section 1370, and one or more ring portions 1380.

In certain embodiments, catalyst standpipe 1300 may be connected to spent catalyst line 1100 and gas line 1200 at first end 1330 and distributor 1400 at second end 1340. In certain embodiments, catalyst standpipe 1300 may be adapted to receive a combined flow of spent catalyst and gas at flow rates in the range of from 10 Mlb/h to 5000 Mlb/h with solids contents in the range of from 5 tons/min to 500 tons/min.

In certain embodiments, spent catalyst line 1100 may comprise first end 1110 and second end 1120. In certain embodiments, spent catalyst line 1100 may be constructed of carbon steel or stainless steel. In certain embodiments, spent catalyst line 1100 may be refractory lined. In certain embodiments, spent catalyst line 1100 may be sized so that it is capable of receiving a flow of spent catalyst from an FCC reactor or stripper. In certain embodiments, spent catalyst line 1100 may be connected to catalyst standpipe 1300 at second end 1120.

In certain embodiments, gas line 1200 may comprise first end 1210 and second end 1220. In certain embodiments, gas line 1200 may be constructed of carbon steel or stainless steel. In certain embodiments, gas line 1200 may be refractory lined. In certain embodiments, gas line 1200 may be sized so that it is capable of receiving a flow of air from a blower capable of regenerating the flow of spent catalyst. In certain embodiments, the flow of air may have a flow rate in the range of from 5,000 SCFM to 40,000 SCFM. In certain embodiments, gas line 1200 may be connected to spent catalyst line 1100 at second end 1220.

In certain embodiments, distributor 1400 may comprise any conventional distributor. Examples of conventional distributor include: channels, pipes, splash plates, and deflector plates.

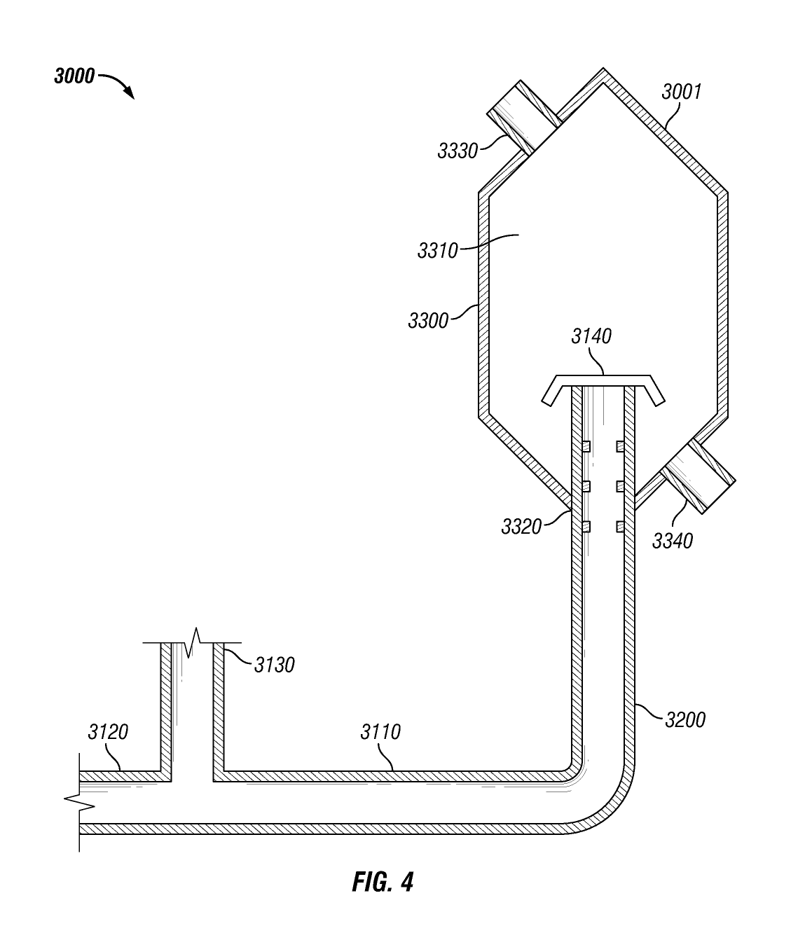

Referring now to FIG. 4, FIG. 4 illustrates a catalyst distributor system 3000 in accordance with certain embodiments of the present disclosure. In certain embodiments, catalyst distributor system 3000 may comprise catalyst distributor 3100 and regenerator vessel 3300. In certain embodiments, catalyst distributor system 3000 may have an on-center standpipe entry design. In other embodiments, catalyst distributor system 3000 may have an off-center standpipe entry design.

In certain embodiments, catalyst distributor 3100 may comprise any combination of features discussed above with respect to catalyst distributor 1000. In certain embodiments, spent catalyst distributer 3100 may comprise: catalyst standpipe 3110, gas line 3120, spent catalyst transfer line 3130, and distributor 3140. In certain embodiments, catalyst standpipe 3110, gas line 3120, spent catalyst transfer line 3130, and distributor 3140 are in fluid communication with each other.

In certain embodiments, catalyst standpipe 3110 may comprise any combination of features discussed above with respect to catalyst standpipe 100 and/or catalyst standpipe 1300.

In certain embodiments, gas line 3120 may comprise any combination of features discussed above with respect to gas line 1120.

In certain embodiments, spent catalyst transfer line 3130 may comprise any combination of features discusses above with respect to spent catalyst transfer line 1130.

In certain embodiments, distributor 3140 may comprise any combination of features discussed above with respect to distributor 1140.

In certain embodiments, a portion of catalyst standpipe 3100 and/or distributor 3140 may be disposed within regenerator vessel 3300. For example, as shown in FIG. 4, distributor 3140 and a portion of catalyst standpipe 3130 may be disposed within regenerator vessel 3300. In certain embodiments, a portion of catalyst standpipe 3100 may be disposed outside of regenerator vessel 3300. For example, as shown in FIG. 4, spent catalyst transfer line 3130, gas line 3120, and a portion of catalyst standpipe 3100 may be disposed outside of regenerator vessel 3300.

In certain embodiments, regenerator vessel 3300 may be a fluidized bed regenerator. In certain embodiments, regenerator vessel 3300 may be any regenerator vessel suitable for use in regenerating a spent catalyst from an FCC reactor.

In certain embodiments, regenerator 3300 may comprise outer walls 3301. In certain embodiments, outer walls 3301 may define an internal chamber 3310, a spent catalyst inlet 3320, regenerator standpipe 3330, and flue gas outlet 3340. In certain embodiments, catalyst standpipe 3100 may pass through spent catalyst inlet 3320 to allow a combined stream of spent catalyst and gas to enter into internal chamber 3310. In certain embodiments, regenerator vessel 3300 may be capable of regenerating the spent catalyst in the combined stream of spent catalyst and gas. In certain embodiments, regenerator standpipe 3330 may allow for the regenerated spent catalyst to exit the regenerator 3300. In certain embodiments, flue gas outlet 3340 may allow for the flue gas to exit regenerator 3300. In certain embodiments, regenerator standpipe may allow for a submerged discharge of spent catalyst or an above-the-bed discharge.

In certain embodiments, the present disclosure provides a method comprising: providing a regenerator system comprising a catalyst distributor system comprising a catalyst standpipe comprising a horizontal section, a sloped section, and vertical section, wherein the vertical section comprises one or more ring portions, a gas line, a spent catalyst transfer line, and a distributor and a regenerator vessel; introducing a flow of gas into the gas line; and introducing a flow of spent catalyst into the spent catalyst transfer line.

In certain embodiments, the catalyst distributor system may comprise any catalyst distributor system discussed above with respect to catalyst distributor system 3000.

In certain embodiments, introducing a flow of gas into the gas line may comprise introducing a flow of air or oxygen into the gas line. In certain embodiments, the flow of gas may have a flow rate in the range of from 5,000 ACFM to 40,000 ACFM.

In certain embodiments, introducing a flow of spent catalyst into the spent catalyst transfer line may comprise introducing a flow of spent catalyst from an FCC reactor into the spent catalyst transfer line. In certain embodiments, the flow of spent catalyst may be an amount in the range of 10 Mlb/hr to 5000 Mlb/hr.

In certain embodiments, the method may further comprise combining the flow of gas and the flow of spent catalyst to form a combined flow of spent catalyst and gas. In certain embodiments, the combined follow of spent catalyst and gas may be an amount in the range of from 10 Mlb/h to 5000 Mlb/h with a solids content in the range of form 5 tons/min to 500 tons/min. In certain embodiments, the method may further comprise allowing the flow of spent catalyst and gas to enter into the regenerator via the catalyst standpipe. In certain embodiments, the method may further comprise regenerating the spent catalyst in the regenerator vessel.

To facilitate a better understanding of the present invention, the following examples of specific embodiments are given. In no way should the following examples be read to limit, or to define, the scope of the invention.

### EXAMPLES

### Example 1

Computer simulations were conducted to test the distribution efficiency of a catalyst standpipe system including a set of rings in the spent catalyst riser portion of the standpipe system. The distribution of catalyst in the spent catalyst riser and the ultimate distribution of catalyst in the regenerator vessel were measured. Placement of the ring devices in the spent catalyst riser resulted in improved distribution of the solids in the regenerator bed, improved density of the solid-gas mixture delivered to the regenerator and reduction particle gas segregation in the spent catalyst riser. The spent catalyst system was tested at FCC operating conditions with full gas and solids flowrates and operating temperatures and pressures.

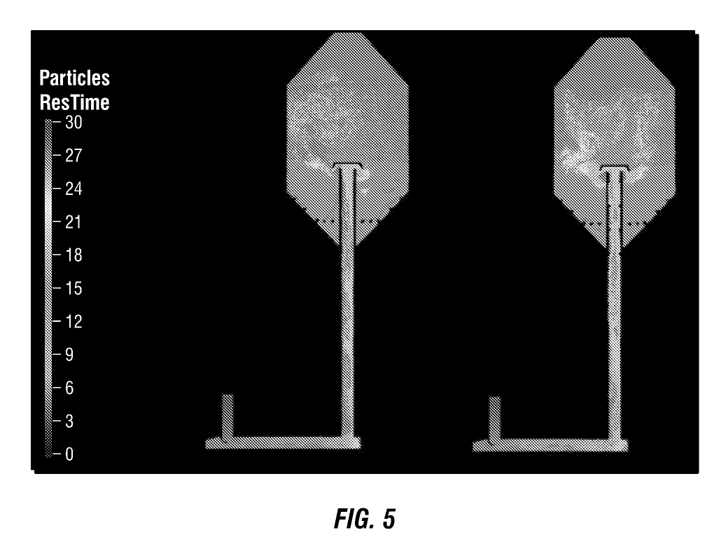

A chart depicting the particle residence time profile of the solids is shown in FIG. 5. As can be seen in FIG. 5, a more uniform particle residence time distribution was generated in the second embodiment, along with a more uniform particle distribution in the riser, reduced backflow of particles along the riser wall, and a reduction in the standard deviation for residence time on particles on the wall.

Thus, the results show that the catalyst standpipes disclosed herein perform at a higher level than conventional standpipes.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A catalyst standpipe comprising a horizontal section, a sloped section, and vertical section, wherein the horizontal section, the sloped section, and/or the vertical section comprises one or more ring portions.

2. The catalyst standpipe of claim 1, wherein the one or more ring portions comprise catalyst standpipe inserts.

3. The catalyst standpipe of claim 2, wherein the catalyst standpipe inserts comprise a beveled or tapered inner surface.

4. The catalyst standpipe of claim 2, wherein the catalyst standpipe inserts have an inner diameter in the range of from 0.25 meters to 0.5 meters and an outer diameter in the range of from 0.5 meters to 1 meter.

5. The catalyst standpipe of claim 2, wherein the catalyst standpipe inserts have a height in the range of from 0.05 meters to 0.1 meters.

6. The catalyst standpipe of claim 1, wherein the one or more ring portions comprise protrusions of a tubular wall of the vertical section.

7. The catalyst standpipe of claim 6, wherein the protrusions extend into a hollow interior of the vertical section a distance in the range of from 0.2% to 10% of the radius of the hollow interior.

8. The catalyst standpipe of claim 6, wherein the protrusions have a length in the range of from 0.1 meters to 0.15 meters.

9. The catalyst standpipe of claim 6, wherein the protrusions cover an entire inner circumference of the catalyst standpipe.

10. The catalyst standpipe of claim 1, wherein the vertical section comprise the one or more ring portions

11. The catalyst standpipe of claim 1, wherein the catalyst standpipe comprises three or more ring portions.

12. The catalyst standpipe of claim 10, wherein the one or more ring portions are spaced at least 0.2 riser diameters from each other.

13. The catalyst standpipe of claim 10, wherein the one or more ring portions are spaced at most 10 riser diameters away from each other.

14. The catalyst standpipe of claim 1, wherein the one or more rings portions are capable of creating a reduced effective inner diameter of the vertical section and/or the horizontal section.

15. A regenerator system comprising a catalyst distributor system comprising a catalyst standpipe comprising a horizontal section, a sloped section, and vertical section, wherein the vertical section comprises one or more ring portions, a gas line, a spent catalyst transfer line, and a distributor and a regenerator vessel.

16. The regenerator system of claim 14, wherein the catalyst standpipe comprises the catalyst standpipe of claim 1.

17. The regenerator system of claim 14, wherein a portion of the vertical section is disposed within the regenerator vessel.

18. A method comprising:
providing a regenerator system comprising a catalyst distributor system comprising a catalyst standpipe comprising a horizontal section, a sloped section, and vertical section, wherein the vertical section comprises one or more ring portions, a gas line, a spent catalyst transfer line, and a distributor and a regenerator vessel;
introducing a flow of gas into the gas line; and
introducing a flow of spent catalyst into the spent catalyst transfer line.

19. The method of claim 17, wherein the regenerator system comprises the regenerator system of any one of claims

20. The method of claim 18, further comprising regenerating the spent catalyst in the regenerator.
